(19) United States
(12) Patent Application Publication
(10) Pub. No.: US 2017/0254270 A1
(43) Pub. Date: Sep. 7, 2017

(54) GAS TURBINE ENGINE SYSTEM

(71) Applicant: KAWASAKI JUKOGYO KABUSHIKI KAISHA, Hyogo (JP)

(72) Inventors: Kunio OKADA, Kakogawa-shi, Hyogo (JP); Atsushi HORIKAWA, Akashi-shi, Hyogo (JP); Seiji YAMASHITA, Kobe-shi, Hyogo (JP); Masahide KAZARI, Akashi-shi, Hyogo (JP); Hikaru SANO, Kobe-shi, Hyogo (JP)

(73) Assignee: KAWASAKI JUKOGYO KABUSHIKI KAISHA, Hyogo (JP)

(21) Appl. No.: 15/506,664

(22) PCT Filed: Aug. 21, 2015
(86) PCT No.: PCT/JP2015/004221

§ 371 Date: Feb. 24, 2017

(30) Foreign Application Priority Data
Aug. 27, 2014 (JP) 2014-173040

(51) Int. Cl. F02C 7/232; F01D 17/02; F23R 3/36

(52) U.S. Cl. CPC F02C 7/232; F23R 3/36; F01D 17/02; F05D 2270/301

(57) ABSTRACT

A gas turbine engine system 1 comprises a gas turbine engine 2; a purge gas supply line 4 connected to a first connection section P₁ on the fuel supply line 3 connected to the gas turbine engine 2; a fuel discharge line 7 connected to a second connection section P₂ of the fuel supply line 3 which is located downstream of the first connection section P₁; a blowoff valve 72 disposed on the fuel discharge line 7, and a passage switching device 50 which performs switching of the fuel supply line 3 between a fuel supply mode and a purge mode. A check valve 73 and a flame arrester 74 are disposed on the fuel discharge line 7 at locations that are downstream of the blowoff valve 72.

### TECHNICAL FIELD

The present invention relates to a gas turbine engine system which uses a fuel which is smaller in ignition energy than a conventional fuel (e.g., natural gas).

### BACKGROUND ART

In recent years, as fuels of gas turbine engines, studies have been conducted to utilize hydrogen (by-product hydrogen) produced secondarily in production steps in, for example, petroleum oil, chemical, iron and steel industries, in addition to a liquefied natural gas (LNG) which is a conventional major fuel. By recovering energy in the gas turbine engine which uses the by-product hydrogen as the fuel, the used amount of fossil fuels can be reduced, which contributes to reduction of fuel cost and efficient use of resources, and carbon dioxide is not generated during combustion of hydrogen, which contributes to prevention of global warming.

It is known that a fuel supply device of a gas turbine engine which uses different kinds of fuels purges the fuel from a fuel supply line when the fuel is changed. For example, Patent Literature 1 discloses a purging method in which an inert gas is supplied to a fuel supply line leading to a gas turbine engine, air is supplied to a fuel injection nozzle of a combustor (burner) of the gas turbine engine, and then the inert gas is supplied to the fuel injection nozzle.

### CITATION LIST

### Patent Literature

Patent Literature 1: Japanese-Laid Open Patent Application Publication No. Hei. 11-210494

### SUMMARY OF INVENTION

### Technical Problem

In a case where a hydrogen-containing fuel is used in the conventional gas turbine engine which uses the natural gas as the fuel, an unburned fuel remaining in the gas turbine engine or the fuel supply line thereof during start-up or shut-down, may be mixed with the air and a combustible air-fuel mixture may be generated. The fuel containing hydrogen or by-product hydrogen (hereinafter will be simply referred to as a “hydrogen-containing fuel”) has smaller ignition energy than the natural gas (in other words, the hydrogen-containing fuel is ignited more easily than the natural gas). For this reason, the combustible air-fuel mixture remaining in the gas turbine engine or the fuel supply line thereof during start-up or shut-down, may be ignited, and combusted. This may damage devices and pipes.

### Solution to Problem

To avoid occurrence of the above-described situation, it is considered that the fuel is purged from the gas turbine engine and the fuel supply line thereof. However, typically, the conventional gas turbine engine which uses the natural gas as the fuel, is not provided with a particular purging mechanism, and discharges the fuel to an outside area of the system by a residual pressure, because of a low possibility of occurrence of the above-described combustion and for the purpose of simplification of equipment. Although Patent Literature 1 discloses that the fuel is purged from the fuel supply line of the combustor, consideration is not given to the use of the fuel which is smaller in ignition energy, in the gas turbine engine. For this reason, the combustible air-fuel mixture may be generated during start-up or shut-down.

In view of the above-described circumstances, the present invention has been developed. An object of the present invention is to prevent the fuel from remaining in the fuel supply line and the engine, in the gas turbine engine system which uses the fuel such as the hydrogen-containing fuel, which has smaller ignition energy than the conventional fuel (e.g., natural gas).

A gas turbine engine system of the present invention comprises a gas turbine engine; a fuel supply line connecting the gas turbine engine and a fuel source to each other; a purge gas supply line connecting a first connection section on the fuel supply line and a purge gas source to each other; a fuel discharge line connected to a second connection section of the fuel supply line which is located downstream of the first connection section; and a blowoff valve disposed on the fuel discharge line.

In accordance with the gas turbine engine system having the above-described configuration, a fuel (fuel gas) in the fuel supply line and the gas turbine engine can be replaced by a purge gas. In other words, the fuel can be purged from the gas turbine engine and the fuel supply line connected to the gas turbine engine. Therefore, it becomes possible to prevent a situation in which the fuel remains in the gas turbine engine and the fuel supply line during shut-down of the gas turbine engine, and a combustible air-fuel mixture is generated by mixing the fuel and the air. This makes it possible to prevent occurrence of undesired combustion in the gas turbine engine and the fuel supply line, and damages to devices and pipes by the combustion. As a result, it becomes possible to realize the safe operation of the gas turbine engine which uses the fuel such as the hydrogen-containing fuel, which has smaller ignition energy than the conventional fuel (e.g., natural gas).

The above-described gas turbine engine system preferably further comprises a check valve disposed on the fuel discharge line at a location that is downstream of the blowoff valve. In accordance with this configuration, it becomes possible to prevent a situation in which the air in the outside area of the system flows into the fuel discharge line and the combustible air-fuel mixture is generated.

The above-described gas turbine engine system preferably further comprises a flame arrester disposed at an outlet of the fuel discharge line. In accordance with this configuration, it becomes possible to prevent a situation in which a flame in the outside area of the system flows into the fuel discharge line and the fuel is ignited by the flame.

The above-described gas turbine engine system preferably further comprises a passage switching device which performs switching of the fuel supply line between a fuel supply mode in which the gas turbine engine and the fuel source are connected to each other and a purge mode in which the gas turbine engine and the purge gas source are connected to each other.

The above-described gas turbine engine system preferably further comprises a first pressure sensor which detects an inlet pressure in the gas turbine engine; a second pressure sensor which detects a pressure in the fuel supply line; and a controller which controls the passage switching device to switch the fuel supply line from the fuel supply mode to the purge mode, when a detection value of the second pressure sensor is smaller than a detection value of the first pressure sensor.

The above-described gas turbine engine system preferably further comprises a pressure sensor which detects a pressure in the fuel supply line; and a controller which controls the passage switching device to switch the fuel supply line from the fuel supply mode to the purge mode, when a detection value of the pressure sensor is smaller than a predetermined inlet pressure set in the gas turbine engine. In accordance with the above-described configuration, it becomes possible to prevent a gas containing the unburned fuel in the gas turbine engine from flowing back to the fuel supply line.

In the above gas turbine engine system, the passage switching device may include, for example, a switching valve disposed on the first connection section of the fuel supply line. In this case, the gas turbine engine system preferably further comprises a flow rate control valve disposed on the fuel supply line at a location that is downstream of the second connection section.

In the above gas turbine engine system, the passage switching device may include, for example, a first flow rate control valve disposed on the fuel supply line at a location that is upstream of the first connection section, and a second flow rate control valve disposed on the purge gas supply line. In this configuration, each of the first flow rate control valve and the second flow rate control valve may be a valve capable of adjusting the flow rate of a fluid in a range of zero to 100% or a valve capable of adjusting the flow rate of the fluid between zero and 100%.

### Advantageous Effects of Invention

In accordance with the present invention, in the gas turbine engine system which uses the fuel such as the hydrogen-containing fuel, which has smaller ignition energy than the conventional fuel (e.g., natural gas), the unburned fuel remaining in the fuel supply line and the gas turbine engine is purged therefrom, and thus it becomes possible to prevent the fuel from remaining in the fuel supply line and the gas turbine engine.

### BRIEF DESCRIPTION OF DRAWINGS

FIG. 1 is a block diagram showing the schematic configuration of a gas turbine engine system according to the embodiment of the present invention.

FIG. 2 is a block diagram showing the control configuration of the gas turbine engine system.

FIG. 3 is a flowchart showing a flow of processing performed by a controller.

FIG. 4 is a block diagram showing the schematic configuration of a gas turbine engine system including a passage switching device according to Modified Example 1.

### DESCRIPTION OF EMBODIMENTS

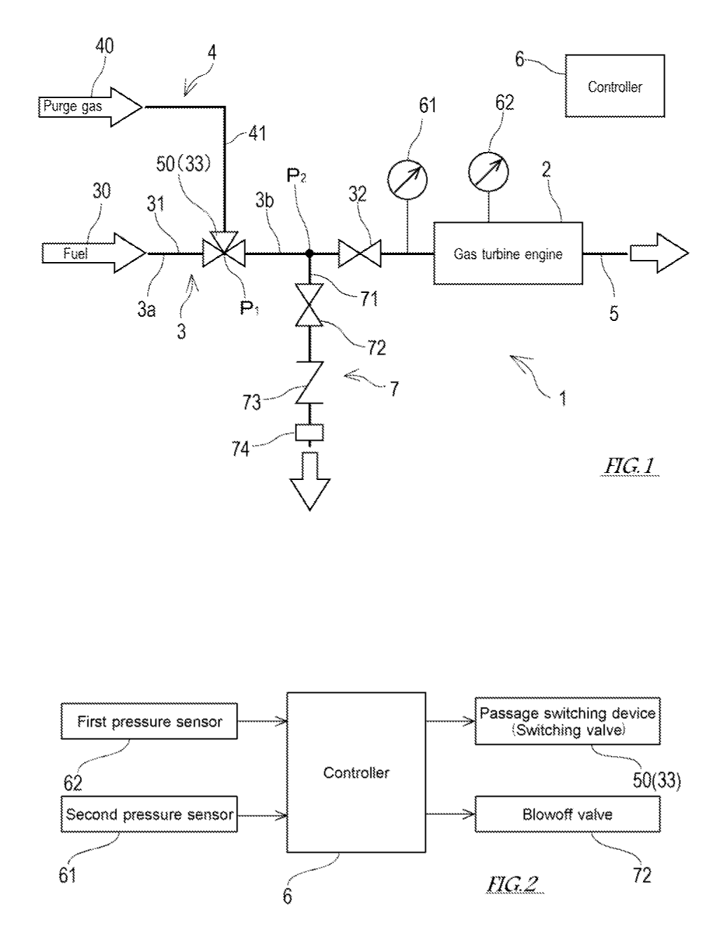

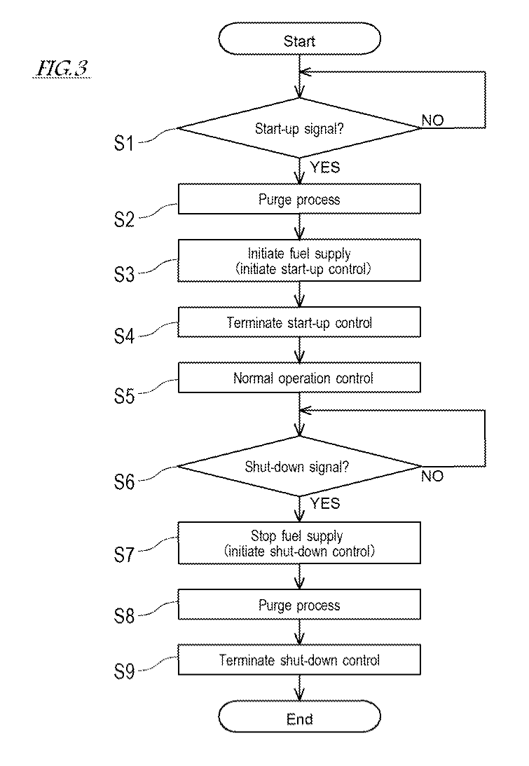

Hereinafter, the embodiment of the present invention will be described with reference to the drawings. As shown in FIGS. 1 and 2, a gas turbine engine system 1 according to the embodiment of the present invention includes a gas turbine engine 2, a fuel supply line 3 which supplies a fuel to the gas turbine engine 2, a purge gas supply line 4 connected to the fuel supply line 3, an exhaust gas discharge line 5 which discharges an exhaust gas emitted from the gas turbine engine 2 to an outside area of the system, a fuel discharge line 7 connected to the fuel supply line 3, a passage switching device 50 which performs switching of a passage of the fuel supply line 3, and a controller 6 which controls the operation of the gas turbine engine system 1.

The gas turbine engine 2 includes a compressor (not shown), a combustor (burner) (not shown), and a turbine (not shown). In the gas turbine engine 2, an air-fuel mixture of a fuel and air having been compressed in the compressor is combusted in the combustor to generate a combustion gas, and the combustion gas is supplied to the turbine to rotate turbine blades, so that the heat energy of the combustion gas is converted into rotational motion energy. The combustion gas (exhaust gas) is discharged from the turbine to the exhaust gas discharge line 5. The gas turbine engine 2 is provided with a first pressure sensor 62 which detects an inlet pressure (turbine inlet pressure) in the turbine of the gas turbine engine 2. The turbine inlet pressure detected by the first pressure sensor 62 is output to the controller 6.

As the fuel of the gas turbine engine 2, the hydrogen-containing fuel which has smaller ignition energy and higher in combustion speed than the natural gas is used. Examples of the hydrogen-containing fuel include hydrogen, by-product hydrogen, a gas containing the hydrogen or the by-product hydrogen which is diluted, the natural gas containing the hydrogen or the by-product hydrogen, and the like.

The fuel supply line 3 includes a fuel supply pipe 31 connecting a fuel source 30 to the combustor of the gas turbine engine 2. A fuel passage is provided inside the fuel supply pipe 31. The purge gas supply line 4 is connected to a first connection section P₁ on the fuel supply line 3. The purge gas supply line 4 includes a purge gas supply pipe 41 connecting a purge gas source 40 in which a purge gas is stored, to the fuel supply line 3. A purge gas passage is formed inside the purge gas supply pipe 41. As the purge gas, for example, an inert gas such as nitrogen is used.

A switching (selector) valve 33 which is one example of the passage switching device 50 is provided at the first connection section P₁ on the fuel supply line 3. The switching valve 33 is a three-way valve. Ports of the switching valve 33 are connected to an upstream section 3a of the fuel supply line 3 which is upstream of the first connection section P₁, a downstream section 3b of the fuel supply line 3 which is downstream of the first connection section P₁, and the purge gas supply line 4, respectively. The switching valve 33 is configured to perform selective switching of the state of the fuel supply line 3, between a “fuel supply mode” in which the gas turbine engine 2 and the fuel source 30 are connected to each other and a “purge mode” in which the gas turbine engine 2 and the purge gas source 40 are connected to each other, in response to a control signal provided by the controller 6. In the fuel supply mode, the switching valve 33 connects the upstream section 3a of the fuel supply line 3 and the downstream section 3b of the fuel supply line 3 to each other. In the purge mode, the switching valve 33 connects the upstream section 3a of the fuel supply line 3 and the purge gas supply line 4 to each other.

A second pressure sensor 61 is connected to the downstream section 3b of the fuel supply line 3 to detect a pressure (fuel supply pressure) in the pipe of the fuel supply line 3. The fuel supply pressure detected by the second pressure sensor 61 is output to the controller 6.

The fuel discharge line 7 is connected to a second connection section P₂ of the fuel supply line 3 which is located downstream of the first connection section P₁. The fuel discharge line 7 includes a fuel discharge pipe 71, one end portion of which is connected to the downstream section 3b of the fuel supply line 3, and the other end of which is opened to atmosphere air. A passage through which the fuel is discharged to the outside area of the system is formed inside the fuel discharge pipe 71.

The fuel discharge line 7 is provided with a blowoff valve 72. The blowoff valve 72 operates in response to a control signal provided by the controller 6 in such a manner that the blowoff valve 72 is opened to discharge a surplus gas when the pressure in the fuel supply line 3 which is detected by the second pressure sensor 61 becomes equal to or higher than a predetermined value, and is closed when the pressure in the fuel supply line 3 becomes lower than the predetermined value. By this operation of the blowoff valve 72, the fuel (or the purge gas) in the fuel supply line 3 is discharged to the outside area of the system through the fuel discharge line 7, when the pressure in the downstream section 3b of the fuel supply line 3 becomes equal to or higher than the predetermined value.

The fuel discharge line 7 is provided with a check valve 73 at a location that is downstream of the blowoff valve 72. The check valve 73 permits the gas to be discharged from the fuel discharge line 7 to the atmospheric air (outside area of the system) and inhibits the atmospheric air from flowing into the fuel discharge line 7. The check valve 73 can prevent a situation in which an unburned fuel and the air are mixed, and thereby a combustible air-fuel mixture is generated in the fuel discharge line 7.

The fuel discharge line 7 is provided with a flame arrester 74 at a location that is downstream of the check valve 73, specifically, at a downstream end (namely, outlet of the fuel discharge pipe 71) of the fuel discharge line 7 or a location that is in the vicinity of the downstream end. The flame arrester 74 is configured to absorb heat or a flame which is present outside the fuel discharge line 7 and is about to enter the fuel discharge line 7 to prevent the entry of the flame into the fuel discharge line 7. The flame arrester 74 is composed of, for example, a plurality of metal meshes stacked together (laminated) in a flow direction of a fluid. The flame arrester 74 can prevent ignition of the unburned fuel in the fuel discharge line 7.

The fuel supply line 3 is provided with a flow rate control valve 32 at a location that is downstream of the second connection section P₂. The flow rate control valve 32 is, for example, a control valve, and includes an adjustment valve body which directly contacts the fluid to control the flow rate of the fluid, and a drive section which moves an inner valve of the adjustment valve body, in response to a control signal provided by the controller 6. Although the flow rate control valve 32 is a flow rate control valve capable of adjusting the flow rate of the fluid in a range of zero to 100%, it may be an on-off valve which switches the flow rate of the fluid between zero and 100%.

The controller 6 is configured to send the controls signals to the fuel discharge pipe 71 and the switching valve 33, based on detection signals received from the first pressure sensor 62 and the second pressure sensor 61. The controller 6 is a computer, and includes CPU, ROM, RAM, I/F, I/O (these are not shown), and the like. The controller 6 is configured to perform processing associated with the operation control for the gas turbine engine system 1 as will be described later in such a manner that software such as programs stored in the ROM and hardware such as the CPU cooperate with each other. In the example of FIG. 2, the control constituents of the switching valve 33, among the constituents of the gas turbine engine system 1, are shown, and other constituents are not shown.

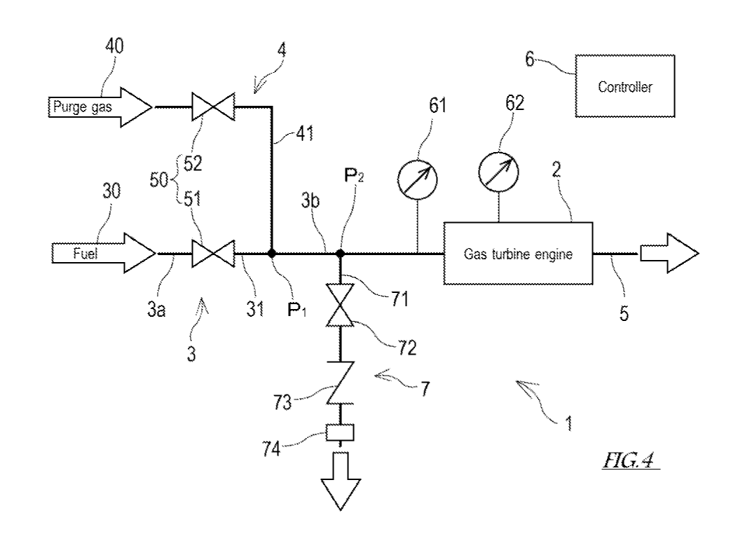

An operation control method of the gas turbine engine system 1 which is performed by the controller 6 will be described. FIG. 3 is a flowchart showing a flow of the processing performed by the controller 6. In the gas turbine engine system 1 during stand-by of start-up, the flow rate control valve 32 is closed, and the switching valve 33 performs switching to cause the fuel supply line 3 to be in the purge mode.

As shown in FIG. 3, when the controller 6 receives a start-up signal (YES in step S1), it performs a purge process (step S2). In the purge process, the controller 6 opens the flow rate control valve 32 in a state in which the fuel supply line 3 is in the purge mode. Thereby, the purge gas is supplied from the purge gas source 40 to the gas turbine engine 2 through the purge gas supply line 4 and the downstream section 3b of the fuel supply line 3. The purge gas is supplied for a sufficient time or at a sufficient amount so that the gas is purged from the gas turbine engine 2, the fuel supply line 3 connected to the gas turbine engine 2, and the exhaust gas discharge line 5 connected to the gas turbine engine 2 (hereinafter these will also be referred to an inside area of the system), to the outside area of the system, and is replaced by the purge gas. When the supply of the purge gas is completed, the controller 6 closes the flow rate control valve 32.

When the purge process ends, the controller 6 initiates a start-up control for the gas turbine engine 2 (step S3). In the start-up control for the gas turbine engine 2, the controller 6 performs switching of the passage of the switching valve 33 to cause the fuel supply line 3 to be in the fuel supply mode, and opens the flow rate control valve 32. Thereby, the supply of the fuel to the combustor of the gas turbine engine 2 is initiated. By performing the purge process before the start-up of the gas turbine engine 2 in the above-described manner, it becomes possible to prevent a situation in which the unburned fuel remaining in the inside area of the system is burned undesirably during the start-up.

When the start-up control for the gas turbine engine 2 ends (step S4), then the controller 6 performs a normal operation control (step S5). When the controller 6 receives a shut-down signal while the normal operation control is performed (YES in step S6), it initiates a shut-down control for the gas turbine engine 2 (step S7).

To initiate the shut-down control for the gas turbine engine 2, the controller 6 stops the supply of the fuel to the gas turbine engine 2. At this time, the controller 6 closes the flow rate control valve 32, and performs switching of the passage of the switching valve 33 to cause the fuel supply line 3 to be in the purge mode.

Then, the controller 6 performs the purge process (step S8). In the purge process, the controller 6 initially opens the flow rate control valve 32. Thereby, the purge gas is supplied from the purge gas source 40 to the gas turbine engine 2 through the purge gas supply line 4 and the downstream section 3b of the fuel supply line 3. The purge gas is supplied for a sufficient time or at a sufficient amount so that the gas is purged from the inside area of the system to the outside area of the system, and is replaced by the purge gas. When the supply of the purge gas is completed, the controller 6 closes the flow rate control valve 32.

A residual pressure in the fuel supply line 3 is released because the gas is discharged to the outside area of the system through the fuel discharge line 7 and the exhaust gas discharge line 5. In some cases, a gas containing an unburned fuel flows into the fuel discharge line 7 because of the release of the residual pressure. However, the check valve 73 operates to prevent entry of the air into the fuel discharge line 7. Therefore, the generation of the combustible air-fuel mixture can be suppressed.

When the gas turbine engine 2 is completely shut-down after the purge process has ended, the controller 6 terminates the shut-down control for the gas turbine engine 2 (step S9). By performing the purge process before the gas turbine engine 2 is completely shut-down, as described above, it becomes possible to suppress a situation in which the unburned fuel remains in the inside area of the system during the shut-down, and the combustible air-fuel mixture is generated by mixing the residual unburned fuel and the air. Since the generation of the combustible air-fuel mixture can be suppressed, the combustion of the combustible air-fuel mixture can be prevented, and damages to the devices and pipes of the gas turbine engine system 1 can be prevented.

In the gas turbine engine 2 in a state in which the normal operation control is performed, if the turbine inlet pressure exceeds the fuel supply pressure, the exhaust gas containing the unburned fuel from the gas turbine engine 2 may flow back to the fuel supply line 3 and thereby the combustible air-fuel mixture may be generated. To avoid this, the controller 6 monitors a detection value of the first pressure sensor 62 and a detection value of the second pressure sensor 61 during the normal operation control, and forcibly shuts-down the gas turbine engine 2 at a time point when the detection value (fuel supply pressure) of the second pressure sensor 61 has become lower than the detection value (turbine inlet pressure) of the first pressure sensor 62. In the above configuration, a predetermined turbine inlet pressure set in the controller 6 may be used instead of the detection value of the first pressure sensor 62.

In the forcible shut-down of the gas turbine engine 2, the controller 6 performs the step S7 to the step S9. In the above-described manner, in the gas turbine engine system 1 according to the present embodiment, it becomes possible to prevent the combustion gas in the combustor of the gas turbine engine 2 from flowing back to the fuel supply line 3.

As described above, in the gas turbine engine system 1 according to the present embodiment, the purge process for the fuel supply line 3, the gas turbine engine 2, and the exhaust gas discharge line 5 is performed before the start-up and shut-down of the gas turbine engine 2. This makes it possible to prevent the unburned fuel from remaining in the inside area of the system during the shut-down of the gas turbine engine 2. Therefore, it becomes possible to prevent a situation in which during the shut-down of the gas turbine engine 2, the combustible air-fuel mixture is generated by mixing the unburned fuel and the air in the inside area of the system, or the combustible air-fuel mixture is ignited and combusted in the inside area of the system. In addition, it becomes possible to prevent a situation in which the unburned fuel remaining in the inside area of the system is undesirably burned during next start-up of the gas turbine engine 2. As a result, the gas turbine engine system 1 can operate safely and stably.

Although the passage switching device 50 of the above-described embodiment includes the switching valve 33, the passage switching device 50 is not limited to the above-described embodiment. Hereinafter, the gas turbine engine system 1 including the passage switching device 50 according to Modified Example 1 will be described. FIG. 4 is a block diagram showing the schematic configuration of the gas turbine engine system 1 including the passage switching device 50 according to Modified Example 1. In the description of the present modified example, the members which are identical to or similar to those of the above-described embodiment are designated by the same reference symbols in the drawing and will not be described in repetition.

As shown in FIG. 4, the passage switching device 50 according to Modified Example 1 includes a fuel flow rate control valve 51 (first flow rate control valve) provided on the upstream section 3a of the fuel supply line 3 at a location that is upstream of the first connection section P₁, and a purge gas flow rate control valve 52 (second flow rate control valve) provided on the purge gas supply line 4. Each of the fuel flow rate control valve 51 and the purge gas flow rate control valve 52 is, for example, a control valve, and includes an adjustment valve body which directly contacts the fluid and controls the flow rate of the fluid, and a drive section which moves an inner valve of the adjustment valve body, in response to a control signal provided by the controller 6. Although each of the fuel flow rate control valve 51 and the purge gas flow rate control valve 52 is a flow rate control valve capable of adjusting the flow rate of the fluid in a range of zero to 100%, it may be an on-off valve which switches the flow rate of the fluid between zero and 100%.

In the passage switching device 50 according to Modified Example 1 having the above-described configuration, the fuel flow rate control valve 51 is opened and the purge gas flow rate control valve 52 is closed to cause the fuel supply line 3 to be in the fuel supply mode in which the gas turbine engine 2 and the fuel source 30 are connected to each other. In contrast, the fuel flow rate control valve 51 is closed and the purge gas flow rate control valve 52 is opened to cause the fuel supply line 3 to be in the purge mode in which the gas turbine engine 2 and the purge gas source 40 are connected to each other. The controller 6 controls the above-described passage switching of the fuel supply line 3 performed by the passage switching device 50.

So far, the preferred embodiment (and its modified example) of the present invention have been described. The above-described configuration can be changed as described below, for example.

For example, although in the above-described embodiment, the check valve 73 and the flame arrester 74 are independently provided. A check valve with a flame arrester having an integrated function of the check valve 73 and the flame arrester 74 may be alternatively provided. Although both of the check valve 73 and the flame arrester 74 are preferably provided on the fuel discharge line 7, at least one of the check valve 73 and the flame arrester 74 may be provided on the fuel discharge line 7.

Further, for example, at least a portion of the passage of the fuel discharge line 7 may be configured as a discharge chimney. In this case, the flame arrester 74 is disposed in the vicinity of an exit of the discharge chimney, and the check valve 73 may be disposed on the discharge chimney at a location that is upstream of the flam arrester 74.

### REFERENCE SIGNS LIST

1 gas turbine engine system

2 gas turbine engine

3 fuel supply line

30 fuel source

31 fuel supply pipe

32 flow rate control valve

33 switching valve

40 purge gas source

4 purge gas supply line

41 purge gas supply pipe

5 exhaust gas discharge line

6 controller

61 second pressure sensor

62 first pressure sensor

7 fuel discharge line

71 fuel discharge pipe

72 blowoff valve

73 check valve

74 flame arrester

50 passage switching device

51 fuel flow rate control valve (first flow rate control valve)

52 purge gas flow rate control valve (second flow rate control valve)

1. A gas turbine engine system comprising:
a gas turbine engine;
a fuel supply line connecting the gas turbine engine and a fuel source to each other;
a purge gas supply line connecting a first connection section on the fuel supply line and a purge gas source to each other;
a fuel discharge line connected to a second connection section of the fuel supply line which is located downstream of the first connection section; and
a blowoff valve disposed on the fuel discharge line.

2. The gas turbine engine system according to claim 1, further comprising:
a check valve disposed on the fuel discharge line at a location that is downstream of the blowoff valve.

3. The gas turbine engine system according to claim 1, further comprising:
a flame arrester disposed at an outlet of the fuel discharge line.

4. The gas turbine engine system according to claim 1, further comprising:
a passage switching device which performs switching of the fuel supply line between a fuel supply mode in which the gas turbine engine and the fuel source are connected to each other and a purge mode in which the gas turbine engine and the purge gas source are connected to each other.

5. The gas turbine engine system according to claim 4, further comprising:
a first pressure sensor which detects an inlet pressure in the gas turbine engine;
a second pressure sensor which detects a pressure in the fuel supply line; and
a controller which controls the passage switching device to switch the fuel supply line from the fuel supply mode to the purge mode, when a detection value of the second pressure sensor is smaller than a detection value of the first pressure sensor.

6. The gas turbine engine system according to claim 4, further comprising:
a pressure sensor which detects a pressure in the fuel supply line; and
a controller which controls the passage switching device to switch the fuel supply line from the fuel supply mode to the purge mode, when a detection value of the pressure sensor is smaller than a predetermined inlet pressure set in the gas turbine engine.

7. The gas turbine engine system according to claim 4,
wherein the passage switching device includes a switching valve disposed on the first connection section of the fuel supply line.

8. The gas turbine engine system according to claim 7, further comprising:
a flow rate control valve disposed on the fuel supply line at a location that is downstream of the second connection section.

9. The gas turbine engine system according to claim 4,
wherein the passage switching device includes a first flow rate control valve disposed on the fuel supply line at a location that is upstream of the first connection section, and a second flow rate control valve disposed on the purge gas supply line.

10. The gas turbine engine system according to claim 2, further comprising:
a flame arrester disposed at an outlet of the fuel discharge line.

11. The gas turbine engine system according to claim 2, further comprising:
a passage switching device which performs switching of the fuel supply line between a fuel supply mode in which the gas turbine engine and the fuel source are connected to each other and a purge mode in which the gas turbine engine and the purge gas source are connected to each other.
